(19) United States
(12) Patent Application Publication
(10) Pub. No.: US 2026/0286799 A1
(43) Pub. Date: Sep. 24, 2026

(54) PUMP INSTALLATION APPARATUS, PUMP INSTALLATION METHOD, AND PUMP REMOVING METHOD

(71) Applicant: EBARA CORPORATION, Tokyo (JP)

(72) Inventors: Shuichiro HONDA, Tokyo (JP); Tetsuji KASATANI, Tokyo (JP); Kei WATAJI, Tokyo (JP); Mitsutaka IWAMI, Tokyo (JP); Hyuga KIKUCHI, Tokyo (JP); Asaki SUZUKI, Tokyo (JP)

(21) Appl. No.: 19/168,523

(22) PCT Filed: Mar. 25, 2024
(86) PCT No.: PCT/JP2024/011705

§ 371 Date: Sep. 24, 2025

(30) Foreign Application Priority Data
Mar. 29, 2023 (JP) 2023-053021

(51) Int. Cl. E21B 23/14; E21B 17/00; E21B 17/02; E21B 19/00

(52) U.S. Cl. CPC E21B 23/14; E21B 17/003; E21B 17/028; E21B 19/008

(57) ABSTRACT

The pump installation apparatus includes a working chamber forming a closed working space, an actuator-driven door covering an upper opening of a pump column, a suspension cable for suspending a submersible pump in the pump column, a power cable for supplying electric power to the submersible pump, and a crane for raising and lowering the suspension cable and the power cable. The upper opening of the pump column, the actuator-driven door, and the crane are located in the working space.

### TECHNICAL FIELD

The present invention relates to a pump installation apparatus for installing a submersible pump for pressurizing liquefied gas, such as liquefied ammonia, liquefied natural gas (LNG), liquid hydrogen, etc., in a pump column and removing the submersible pump from the pump column. The present invention further relates to a method of installing a submersible pump in a pump column using the pump installation apparatus and a method of removing the submersible pump from the pump column using the pump installation apparatus.

### BACKGROUND ART

Natural gas is widely used for thermal power generation and used as a raw material for chemicals. Furthermore, ammonia and hydrogen are expected to be energies that do not generate carbon dioxide that causes global warming. Applications of hydrogen as an energy include fuel cell and turbine power generation. Natural gas, ammonia, and hydrogen are in a gaseous state at normal temperature, and therefore natural gas, ammonia, and hydrogen are cooled and liquefied for their storage and transportation. Liquefied gas, such as liquefied natural gas (LNG), liquefied ammonia, and liquid hydrogen, is temporarily stored in a liquefied-gas storage tank and then delivered to a power plant, factory, or the like by a pump.

FIG. 23 is a schematic diagram showing a conventional example of a liquefied-gas storage tank in which liquefied gas is stored and a pump for pumping up the liquefied gas. A pump 500 is installed in a vertical pump column 505 disposed in a liquefied-gas storage tank 501. An upper opening of the pump column 505 is closed by a top cover 510. The interior of the pump column 505 is filled with the liquefied gas, and the entire pump 500 is immersed in the liquefied gas. Therefore, the pump 500 is a submersible pump that can operate in the liquefied gas.

When the pump 500 is operated, the liquefied gas in the liquefied-gas storage tank 501 is sucked into the pump column 505, ascends the pump column 505, and is discharged from the pump column 505 through a liquefied-gas discharge port 509. The pump column 505 has a purge-gas introduction port 512. This purge-gas introduction port 512 is closed when the pump 500 is in operation.

FIG. 24 is a diagram for explaining an operation of carrying the pump 500 into the pump column 505 and an operation of pulling up the pump 500 from the pump column 505. When the pump 500 is to be installed in the pump column 505 and when the pump 500 is to be removed from the pump column 505 for the purpose of maintenance, the top cover 510 is removed and a cable 508 is coupled to a hoist 513. The pump 500 is suspended from the cable 508 and is raised or lowered within the pump column 505 by the hoist 513.

The liquefied gas remaining in the pump column 505 is gasified to form boil-off gas (BOG). During the operations of carrying in the pump 500 and pulling up the pump 500, a purge gas is introduced into the pump column 505 through the purge-gas introduction port 512 to prevent the boil-off gas (BOG) from being released into the atmosphere. In addition, the purge gas serves to prevent air from entering the pump column 505. An inert gas, such as N₂ gas or He gas, is used as the purge gas.

### CITATION LIST

### Patent Literature

Patent document 1: Japanese Patent No. 3197645
Patent document 2: Japanese Patent No. 3198248
Patent document 3: Japanese Patent No. 3472379

### SUMMARY OF INVENTION

### Technical Problem

However, the upper opening of the pump column 505 is larger than the width of the pump 500, and therefore a large amount of the purge gas is required in order to prevent air from entering the pump column 505 while preventing the boil-off gas (BOG) from being discharged outside the pump column 505. In particular, He gas is expensive, which increases costs of carrying in and pulling up the pump 500.

In addition, during the operations of carrying in and pulling up the pump 500, a working person may be exposed to the boil-off gas, and as a result, a safe working environment may not be ensured. In particular, when the cable 508 is pulled up from the pump column 505, the cable 508, which has been in contact with the liquefied gas, has an extremely low temperature, and handling of such cable 508 is dangerous.

Therefore, the present invention provides a pump installation apparatus that can reduce an amount of purge gas used to prevent boil-off gas (BOG) from being released from a pump column when a submersible pump is carried into and pulled up from the pump column, and can provide a safe working environment. The present invention further provides a method of installing a submersible pump in a pump column and a method of removing a submersible pump from a pump column using the pump installation apparatus.

### Solution to Problem

In an embodiment, there is provided a pump installation apparatus for installing a submersible pump in a pump column and removing the submersible pump from the pump column, the submersible pump being used to deliver liquefied gas, the pump installation apparatus comprising: a working chamber forming an enclosed working space therein; an actuator-driven door covering an upper opening of the pump column; a suspension cable configured to suspend the submersible pump in the pump column; a power cable configured to supply electric power to the submersible pump; and a crane configured to raise and lower the suspension cable and the power cable, an upper opening of the pump column, the actuator-driven door, and the crane being located in the working space.

In an embodiment, the suspension cable includes a plurality of split suspension cables and a plurality of coupling links configured to couple the plurality of split suspension cables, the power cable includes a plurality of split power cables and a plurality of electric connectors configured to electrically couple the plurality of split power cables, the plurality of electric connectors are attached to the plurality of coupling links, respectively, and the pump installation apparatus further comprises a link operating device configured to operate the plurality of coupling links to cause the plurality of coupling links to couple and separate the plurality of split suspension cables and couple and separate the plurality of split power cables.

In an embodiment, each of the plurality of coupling links includes a first link mechanism coupled to a lower end of each split suspension cable, a second link mechanism coupled to an upper end of each split suspension cable, and a coupling pin configured to couple and separate the first link mechanism and the second link mechanism, and the link operating device is configured to move the coupling pin to couple and separate the first link mechanism and the second link mechanism.

In an embodiment, each of the plurality of electric connectors includes a first electric connector coupled to a lower end of each split power cable and a second electric connector coupled to an upper end of each split power cable, and the first electric connector is held by the first link mechanism, and the second electric connector is held by the second link mechanism.

In an embodiment, each of the plurality of coupling links further includes a positioning device configured to perform positioning of the first link mechanism and the second link mechanism in a vertical direction.

In an embodiment, the positioning device includes a spring that urges the first link mechanism toward the second link mechanism.

In an embodiment, the working chamber comprises a purge-gas inlet port communicating with the working space, and a purge-gas supply line coupled to the purge-gas inlet port.

In an embodiment, there is provided a method of installing a submersible pump in a pump column, the submersible pump being used to deliver liquefied gas, the method comprising: opening an actuator-driven door disposed within an enclosed working space formed by a working chamber, the actuator-driven door being coupled to an upper portion of the pump column; coupling a suspension cable and a power cable to the submersible pump within the working space; and lowering the suspension cable, the power cable, and the submersible pump in the pump column by a crane disposed in the working space, an upper opening of the pump column being located in the working space.

In an embodiment, the suspension cable includes a plurality of split suspension cables and a plurality of coupling links configured to couple the plurality of split suspension cables, the power cable includes a plurality of split power cables and a plurality of electric connectors configured to electrically couple the plurality of split power cables, the plurality of electric connectors are attached to the plurality of coupling links, respectively, and lowering the suspension cable, the power cable, and the submersible pump in the pump column comprises lowering the plurality of split suspension cables, the plurality of split power cables, and the submersible pump in the pump column by the crane while operating the coupling links by a link operating device to couple the plurality of split suspension cables one by one and to couple the plurality of split power cables one by one.

In an embodiment, the method further comprises supplying a purge gas into the working space to expose the submersible pump to the purge gas within the working space before carrying the submersible pump into the pump column.

In an embodiment, there is provided a method of removing a submersible pump from a pump column, the submersible pump being used to deliver liquefied gas, the method comprising: opening an actuator-driven door located in an enclosed working space formed by a working chamber, the actuator-driven door being coupled to an upper portion of the pump column; raising a suspension cable, a power cable, and the submersible pump in the pump column by pulling up the suspension cable and the power cable coupled to the submersible pump with a crane, the crane being disposed in the working space; separating the suspension cable and the power cable from the submersible pump; and raising the submersible pump from the pump column into the working space by the crane, an upper opening of the pump column being located in the working space.

In an embodiment, the suspension cable includes a plurality of split suspension cables and a plurality of coupling links configured to couple the plurality of split suspension cables, the power cable includes a plurality of split power cables and a plurality of electric connectors configured to electrically couple the plurality of split power cables, the plurality of electric connectors are attached to the plurality of coupling links, respectively, and raising the suspension cable, the power cable, and the submersible pump in the pump column comprises raising the plurality of split suspension cables, the plurality of split power cables, and the submersible pump in the pump column by the crane while operating the plurality of coupling links with a link operating device to separate the plurality of split suspension cables one by one and to separate the plurality of split power cables one by one.

In an embodiment, the method further comprises supplying a purge gas into the working space to expose the submersible pump to the purge gas within the working space after raising the submersible pump from the pump column into the working space.

### Advantageous Effects of Invention

According to the present invention, the submersible pump can be automatically installed in the pump column and can be pulled up from the pump column by the remote operation of the crane and the actuator-driven door from outside the working chamber. Therefore, a working person is not exposed to a dangerous atmosphere. In addition, since the upper opening of the pump column is located within the closed working space, boil-off gas (BOG) is not released into the atmosphere. As a result, an amount of the purge gas used to prevent the release of boil-off gas (BOG) into the atmosphere can be substantially zero. Furthermore, when the submersible pump is carried into the pump column, the working space is filled with a gas having the same components as the liquefied gas, thereby preventing entry of gas containing other components, such as air, into the pump column.

The power cable is not permanently installed in the liquefied-gas storage tank, and is carried into and out of the pump column together with the suspension cable. Therefore, when the power cable deteriorates, the power cable can be replaced with new power cable without discharging the liquefied gas from the liquefied-gas storage tank.

### BRIEF DESCRIPTION OF DRAWINGS

FIG. 1 is a diagram showing an embodiment of a pump system for delivering a liquefied gas;

FIG. 2 is a cross-sectional view showing an embodiment of a coupling link;

FIG. 3 is a diagram explaining a manner of coupling a first link mechanism to a second link mechanism;

FIG. 4 is a diagram explaining a manner of coupling the first link mechanism to the second link mechanism;

FIG. 5 is a diagram explaining a manner of coupling the first link mechanism to the second link mechanism;

FIG. 6 is a diagram explaining a manner of coupling the first link mechanism to the second link mechanism;

FIG. 7 is a diagram explaining a manner of separating the first link mechanism from the second link mechanism;

FIG. 8 is a diagram explaining a manner of separating the first link mechanism from the second link mechanism;

FIG. 9 is a top view showing an embodiment of a support plate shown in FIG. 1;

FIG. 10 is a diagram illustrating suspension cables, power cables, and submersible pump before they are carried into a pump column;

FIG. 11 is a diagram illustrating an embodiment of a method of installing the submersible pump in the pump column;

FIG. 12 is a diagram illustrating an embodiment of the method of installing the submersible pump in the pump column;

FIG. 13 is a diagram illustrating an embodiment of the method of installing the submersible pump in the pump column;

FIG. 14 is a diagram illustrating an embodiment of the method of installing the submersible pump in the pump column;

FIG. 15 is a diagram illustrating an embodiment of the method of installing the submersible pump in the pump column;

FIG. 16 is a diagram illustrating an embodiment of the method of installing the submersible pump in the pump column;

FIG. 17 is a diagram illustrating an embodiment of a method of removing the submersible pump from the pump column;

FIG. 18 is a diagram illustrating an embodiment of the method of removing the submersible pump from the pump column;

FIG. 19 is a diagram illustrating an embodiment of the method of removing the submersible pump from the pump column;

FIG. 20 is a diagram illustrating an embodiment of the method of removing the submersible pump from the pump column;

FIG. 21 is a diagram illustrating an embodiment of the method of removing the submersible pump from the pump column;

FIG. 22 is a diagram illustrating an embodiment of the method of removing the submersible pump from the pump column;

FIG. 23 is a schematic diagram showing a conventional example of a liquefied-gas storage tank in which liquefied gas is stored, and a pump for pumping up the liquefied gas; and

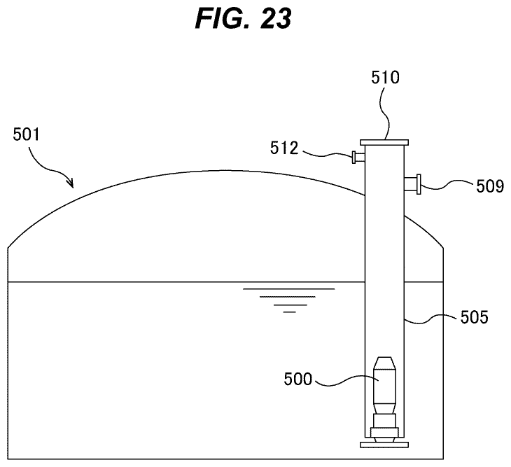

FIG. 24 is a diagram explaining an operation of carrying the pump into the pump column, and an operation of pulling up the pump out of the pump column.

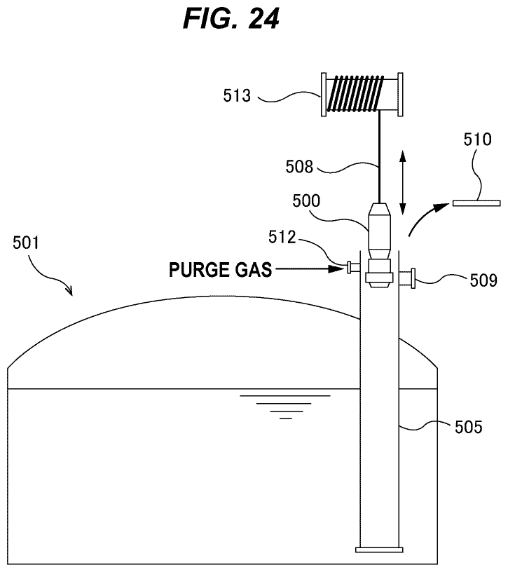

### DESCRIPTION OF EMBODIMENTS

Hereinafter, embodiments of the present invention will be described with reference to the drawings.

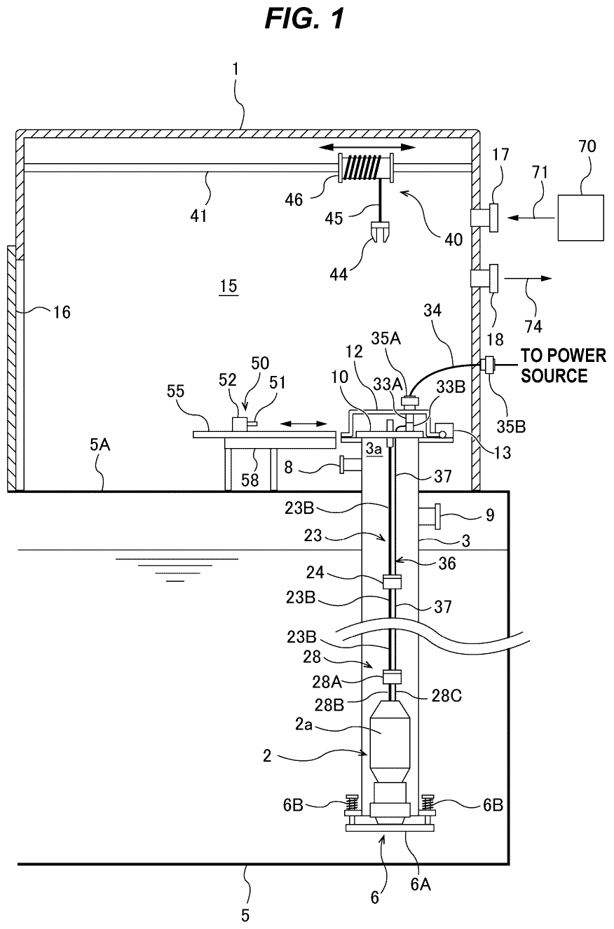

FIG. 1 is a diagram showing one embodiment of a pump system for delivering a liquefied gas. Examples of the liquefied gas that can be delivered by the pump system shown in FIG. 1 include liquefied ammonia, liquid hydrogen, liquid nitrogen, liquefied natural gas, liquefied ethylene gas, and liquefied petroleum gas.

As shown in FIG. 1, the pump system includes a submersible pump 2 configured to deliver the liquefied gas, a pump column 3 in which the submersible pump 2 is disposed, and a head plate 10 configured to close an upper opening 3a of the pump column 3. The pump column 3 is installed in a liquefied-gas storage tank 5 in which the liquefied gas is stored. The pump column 3 is a hollow container extending vertically, and its upper portion protrudes upward from the liquefied-gas storage tank 5. The pump column 3 has a purge-gas introduction port 8 and a discharge port 9. The discharge port 9 is coupled to a liquefied-gas transfer pipe (not shown).

A suction valve 6 is provided on a bottom of the pump column 3. The submersible pump 2 is installed on the suction valve 6 of the pump column 3. The suction valve 6 has a valve element 6A that covers a lower opening of the pump column 3, and a plurality of springs 6B that push the valve element 6A upward. When the submersible pump 2 is not placed on the valve element 6A, the valve element 6A is pressed against a lower end of the pump column 3 by the springs 6B, thereby closing the lower opening of the pump column 3. When the submersible pump 2 is placed on the valve element 6A, the valve element 6A moves downward against the force of the springs 6B due to the weight of the submersible pump 2, thereby opening the suction valve 6. The suction valve 6 may be an actuator-driven valve (e.g., an electric valve).

A suspension cable 23 for suspending the submersible pump 2 in the pump column 3 and a power cable 36 for supplying electric power to an electric motor 2a of the submersible pump 2 extend vertically in the pump column 3. The head plate 10 is placed on an upper end of the pump column 3. The head plate 10 is covered with an actuator-driven door 12. The suspension cable 23, the power cable 36, and a coupling structure 28 are suspended from the head plate 10. The suspension cable 23 extends vertically within the pump column 3. The suspension cable 23 has a plurality of split suspension cables 23B coupled by coupling links 24. The power cable 36 extends vertically along the suspension cable 23 in the pump column 3.

A first electric terminal 35A is fixed to the actuator-driven door 12, and a second electric terminal 35B is fixed to a wall of a working chamber 1. The second electric terminal 35B is coupled to a power source (not shown). The first electric terminal 35A is electrically coupled to the second electric terminal 35B by a coupling cable 34. The coupling cable 34 extends between the first electric terminal 35A and the second electric terminal 35B, and is detachably coupled to the first electric terminal 35A and the second electric terminal 35B.

The first electric terminal 35A, which is fixed to an outer surface of the actuator-driven door 12, is electrically coupled to a first electric contact 33A fixed to an inner surface of the actuator-driven door 12. The first electric terminal 35A and the first electric contact 33A move with opening and closing of the actuator-driven door 12. A second electric contact 33B is fixed to an upper surface of the head plate 10, and the power cable 36 is coupled to the second electric contact 33B. When the actuator-driven door 12 is closed, the first electric contact 33A comes into contact with the second electric contact 33B on the head plate 10, thereby establishing an electrical connection between the first electric contact 33A and the second electric contact 33B. Electric power is supplied to the power cable 36 from the power source (not shown) via the second electric terminal 35B, the coupling cable 34, the first electric terminal 35A, the first electric contact 33A, and the second electric contact 33B. When the actuator door 12 is opened, the first electric contact 33A is disconnected from the second electric contact 33B on the head plate 10, thereby cutting off the power supply.

An upper end of the power cable 36 is electrically coupled to the first electric terminal 35A via the first electric contact 33A and the second electric contact 33B, and a lower end of the power cable 36 is electrically coupled to the electric motor 2a of the submersible pump 2. The power cable 36 has a plurality of split power cables 37. These multiple split power cables 37 are coupled to each other by coupling links 24. An uppermost split power cable 37 is coupled to the second electric contact 33B on the head plate 10.

The coupling structure 28 is attached to the submersible pump 2. The coupling structure 28 is coupled to lower ends of the suspension cable 23 and the power cable 36. More specifically, the coupling structure 28 includes a link mechanism 28A coupled to the suspension cable 23 and the power cable 36, a coupling member 28B coupling the link mechanism 28A to the submersible pump 2, and a conductive member 28C electrically coupling the link mechanism 28A to the electric motor 2a of the submersible pump 2. The coupling member 28B may be a cable, a rod-shaped member, or the like. The conductive member 28C may be composed of a power cable, or the like.

The link mechanism 28A has a width larger than those of the coupling member 28B and the conductive member 28C. The suspension cable 23 is coupled to the submersible pump 2 via the link mechanism 28A and the coupling member 28B. The power cable 36 is electrically coupled to the electric motor 2a of the submersible pump 2 via the conductive member 28C.

When the submersible pump 2 is in operation, the liquefied gas in the liquefied-gas storage tank 5 is introduced into the pump column 3 through the suction valve 6, and the pump column 3 is filled with the liquefied gas. When the submersible pump 2 is in operation, the entire submersible pump 2 is immersed in the liquefied gas. Therefore, the submersible pump 2 is configured to be able to operate in the liquefied gas. The liquefied gas pressurized by the submersible pump 2 is delivered to the outside through the discharge port 9 and the liquefied-gas transfer pipe (not shown). While the submersible pump 2 is in operation, the purge-gas introduction port 8 is closed by a valve (not shown).

Next, a pump installation apparatus for installing the submersible pump 2 in the pump column 3 and removing the submersible pump 2 from the pump column 3 will be described. The pump system includes the pump installation apparatus described below. The pump installation apparatus includes the working chamber 1 forming a closed working space 15 therein, the actuator-driven door 12 covering the upper opening 3a of the pump column 3, the suspension cable 23 for suspending the submersible pump 2 in the pump column 3, the power cable 36 for supplying electric power to the submersible pump 2, and a crane 40 for raising and lowering the suspension cable 23. The upper opening 3a of the pump column 3, the actuator-driven door 12, and the crane 40 are arranged in the working space 15. The working chamber 1 has a working door 16 through which the submersible pump 2, the suspension cable 23, the power cable 36, and other elements are carried into and removed out of the working space 15. This working door 16 is usually closed.

The working chamber 1 is fixed to an upper wall 5A of the liquefied-gas storage tank 5. The working chamber 1 includes a purge-gas inlet port 17 and a gas outlet port 18 that communicate with the working space 15. A purge-gas supply line 71 extending from a purge-gas supply source 70 is coupled to the purge-gas inlet port 17. A vacuum line 74 is coupled to the gas outlet port 18. The vacuum line 74 is coupled to a vacuum source (not shown), such as a vacuum pump. Examples of the purge-gas supply source 70 include a nitrogen-gas supply source, a helium-gas supply source, a hydrogen-gas supply source, or a combination thereof. In one embodiment, the purge-gas supply source 70 may include at least two of different types of purge-gas supply sources, which may be a nitrogen-gas supply source, a helium-gas supply source, and a hydrogen-gas supply source. In this case, multiple purge-gas supply sources may be selectively coupled to the purge-gas supply line 71.

The purge gas used is gas composed of component (or element) having a boiling point lower than or equal to the boiling point of the liquefied gas to be pumped up by the submersible pump 2. This is because of preventing the purge gas from being liquefied when the purge gas contacts the liquefied gas. Examples of purge gas include inert gas, such as nitrogen gas and helium gas. For example, when the liquefied gas to be pumped up by the submersible pump 2 is liquefied natural gas, nitrogen gas is used for the purge gas, since the nitrogen gas is composed of nitrogen having a boiling point (−196° C.) lower than the boiling point (−162° C.) of the liquefied natural gas. In another example, when the liquefied gas to be pumped up by the submersible pump 2 is liquid hydrogen, helium gas is used for the purge gas, since the helium gas is composed of helium having a boiling point (−269° C.) lower than the boiling point of hydrogen (−253° C.).

A part of the purge gas may contain a gas having the same component as that of the liquefied gas. If the purge-gas outlet port 18 is coupled to a gas treatment device, all of the purge gas may be gas of the same component as the liquefied gas. For example, if the liquefied gas is liquid hydrogen, a part or all of the purge gas may be hydrogen gas. In another example, if the liquefied gas is liquefied ammonia, a part or all of the purge gas may be ammonia gas.

The actuator-driven door 12 is coupled to the upper part of the pump column 3. The actuator-driven door 12 covers the upper opening 3a of the pump column 3 and the head plate 10 that closes the upper opening 3a. The actuator-driven door 12 includes an actuator 13, such as an electric motor or an air cylinder. The actuator-driven door 12 is configured to open and close in response to a command signal transmitted from outside the working chamber 1. During operation of the submersible pump 2, the actuator-driven door 12 is closed as shown in FIG. 1.

When the actuator-driven door 12 is closed, a sealed space is formed between the actuator-driven door 12 and the upper part of the pump column 3. The head plate 10 is located in this sealed space. The actuator-driven door 12 can prevent boil-off gas (BOG) that has passed through a minute gap between the head plate 10 and the upper part of the pump column 3 from leaking into the working space 15 of the working chamber 1.

The crane 40 is configured to be movable in the working space 15. More specifically, the crane 40 is movable on a support rail 41 arranged in the working space 15, as indicated by an arrow. The crane 40 can move between a position above the pump column 3 and a position away from the pump column 3. The crane 40 includes a gripping mechanism (or gripper) 44, a wire 45 for suspending the gripping mechanism 44, and a take-up device 46 for reeling out and reeling in the wire 45. The gripping mechanism 44 is configured to be capable of gripping the head plate 10, the suspension cable 23, the coupling link 24, the coupling structure 28, and other elements. Examples of the take-up device 46 include a hoist and a winch. The crane 40 is configured to operate upon receiving a command signal transmitted from outside the working chamber 1.

The suspension cable 23 includes a plurality of split suspension cables 23B and a plurality of coupling links 24 coupling the split suspension cables 23B. In FIG. 1, only one coupling link 24 is illustrated. A length of each split suspension cable 23B is shorter than a length of the pump column 3. The multiple split suspension cables 23B are coupled in series by the coupling links 24. Similarly, the power cable 36 includes a plurality of split power cables 37. The multiple split power cables 37 are coupled in series by the coupling links 24.

The pump installation apparatus further includes a link operating device 50 configured to operate each coupling link 24 to couple and separate the split suspension cables 23B and the split power cables 37, a support plate 55 that supports the link operating device 50, and a plate actuator 58 configured to move the support plate 55 between a position directly above the pump column 3 and a retreated position. The link operating device 50 is disposed on the support plate 55, and the support plate 55 is coupled to the plate actuator 58. The plate actuator 58 is capable of moving the link operating device 50 and the support plate 55 together. The link operating device 50 has an actuator 52, such as a linear motor or an air cylinder, and the link operating device 50 is configured to be movable on the support plate 55. Specifically, the link operating device 50 is capable of moving relative to the support plate 55.

The link operating device 50 has an operating pin 51 that protrudes toward the coupling link 24. When the coupling link 24 is operated by this operating pin 51, the coupling link 24 is configured to couple or separate the split suspension cables 23B and the split power cables 37.

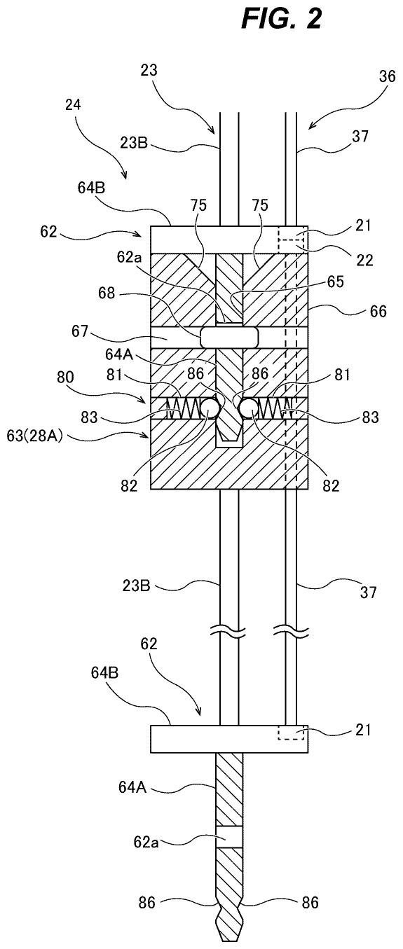

FIG. 2 is a cross-sectional view showing an embodiment of the coupling link 24. As shown in FIG. 2, the coupling link 24 includes a first link mechanism 62, a second link mechanism 63, and a coupling pin 68 that couples and separates the first link mechanism 62 and the second link mechanism 63 to and from each other. The link operating device 50 shown in FIG. 1 is configured to couple and separate the first link mechanism 62 and the second link mechanism 63 to and from each other by moving the coupling pin 68.

The first link mechanism 62 and the second link mechanism 63 are coupled to both ends of each split suspension cable 23B. In the embodiment shown in FIG. 2, the first link mechanism 62 is coupled to a lower end of each split suspension cable 23B, and the second link mechanism 63 is coupled to an upper end of each split suspension cable 23B. The link mechanism 28A of the coupling structure 28 shown in FIG. 1 has the same configuration as the second link mechanism 63, and the following description is applied to the link mechanism 28A of the coupling structure 28 as well.

The power cable 36 has a first electric connector 21 and a second electric connector 22 coupled to both ends of each split power cable 37. In the embodiment shown in FIG. 2, the first electric connector 21 is coupled to a lower end of each split power cable 37, and the second electric connector 22 is coupled to an upper end of each split power cable 37.

The first electric connector 21 is held by the first link mechanism 62, and the second electric connector 22 is held by the second link mechanism 63. When the first electric connector 21, which is coupled to the lower end of the split power cable 37, is coupled to the second electric connector 22 coupled to the upper end of another split power cable 37, these two split power cables 37 are electrically coupled by the first electric connector 21 and the second electric connector 22. The multiple first electric connectors 21 and the multiple second electric connectors 22 are attached to the multiple coupling links 24, respectively.

The first link mechanism 62 has an insertion portion 64A and a flange portion 64B protruding outward from the insertion portion 64A. The insertion portion 64A has a horizontal hole 62a extending horizontally. The first electric connector 21 is held by the flange portion 64B. The second link mechanism 63 has a housing 66 having a vertical hole 65 into which the insertion portion 64A is inserted, and the coupling pin 68 arranged in a horizontal hole 67 formed in the housing 66. The coupling pin 68 is movable within the horizontal hole 67. The horizontal hole 67 extends through the housing 66 in the horizontal direction. A diameter of the horizontal hole 62a of the first link mechanism 62 is larger than a diameter of the coupling pin 68, so that the coupling pin 68 can pass through the horizontal hole 62a of the first link mechanism 62.

The second link mechanism 63 has tapered guide surfaces 75 formed in an upper surface of the housing 66. The tapered guide surfaces 75 are coupled to an upper end of the vertical hole 65 and are inclined downward toward the vertical hole 65. The tapered guide surfaces 75 are provided to guide the insertion portion 64A of the first link mechanism 62 into the vertical hole 65.

The upper end of the split suspension cable 23B is coupled to a lower part of the housing 66. A top portion of the split power cable 37 extends vertically within the housing 66 and is held by the housing 66. Specifically, both the split suspension cable 23B and the split power cable 37 are coupled to the housing 66 of the second link mechanism 63. Therefore, the split suspension cable 23B and the split power cable 37 can move integrally with the second link mechanism 63. The second electric connector 22 is fixed to a top portion of the housing 66. The split power cable 37 extends within the housing 66 and is coupled to the second electric connector 22.

As shown in FIG. 2, when the coupling pin 68 is located across the horizontal hole 62a of the first link mechanism 62, the first link mechanism 62 and the second link mechanism 63 are coupled to each other. On the other hand, when the coupling pin 68 is outside the horizontal hole 62a of the first link mechanism 62, the first link mechanism 62 can be separated from the second link mechanism 63.

The second link mechanism 63 further includes a positioning device 80 configured to perform positioning of the first link mechanism 62 and the second link mechanism 63 in the vertical direction. The positioning device 80 in this embodiment is a ball plunger having balls 82 disposed in horizontal holes 81 formed in the housing 66 and springs 83 for pressing the balls 82 against the insertion portion 64A of the first link mechanism 62. In this embodiment, two sets of balls 82 and springs 83 are provided, but one set or three or more sets of balls 82 and springs 83 may be provided. The insertion portion 64A has recesses 86 on its outer surface. The springs 83 press the balls 82 against the recesses 86, thereby fixing a position of the insertion portion 64A relative to the housing 66 in the vertical direction.

The positioning device 80 including the ball plunger further has a function of pressing the first electric connector 21, held by the first link mechanism 62, against the second electric connector 22 held by the second link mechanism 63. Specifically, the springs 83 urge the first link mechanism 62 toward the second link mechanism 63. Therefore, the positioning device 80 can ensure the electrical connection between the first electric connector 21 held by the first link mechanism 62 and the second electric connector 22 held by the second link mechanism 63.

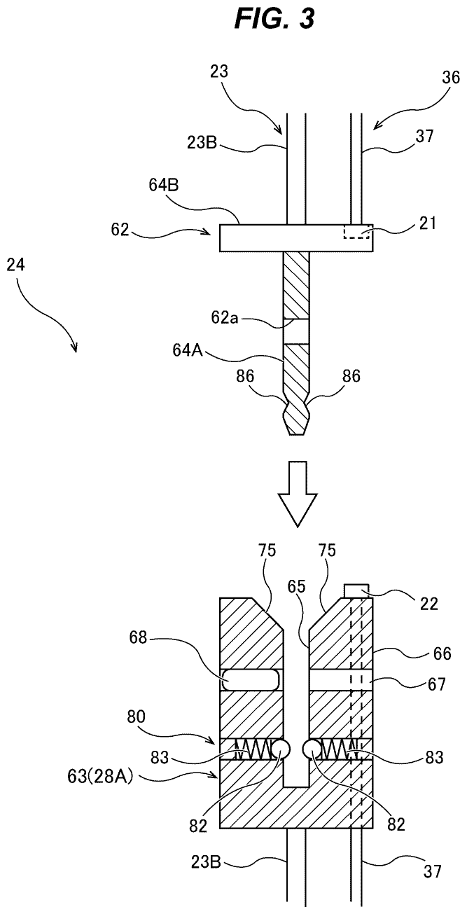

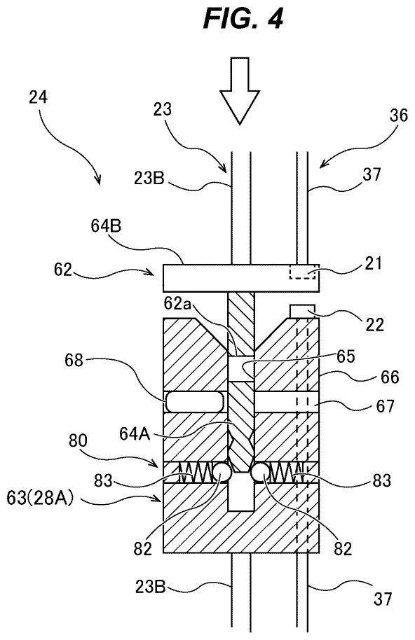

FIGS. 3 to 6 are diagrams for explaining a manner of coupling the first link mechanism 62 to the second link mechanism 63. As shown in FIG. 3, when the coupling pin 68 is located outside the vertical hole 65, the insertion portion 64A of the first link mechanism 62 enters the vertical hole 65 of the second link mechanism 63. A tip of the insertion portion 64A is guided by the tapered guide surfaces 75 and enters the vertical hole 65. As shown in FIG. 4, when the insertion portion 64A of the first link mechanism 62 comes into contact with the balls 82 of the positioning device 80, the insertion portion 64A pushes the balls 82 outward against forces of the springs 83.

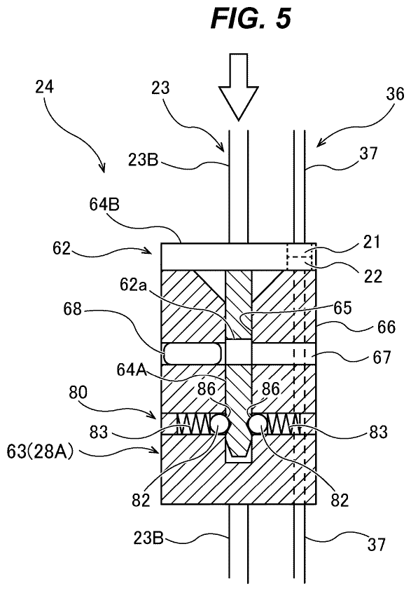

As shown in FIG. 5, when the balls 82 are pressed against the recesses 86 of the insertion portion 64A by the springs 83, the vertical position of the insertion portion 64A relative to the second link mechanism 63 is retained. At this time, the first electric connector 21 held by the first link mechanism 62 is pressed against the second electric connector 22 held by the second link mechanism 63, whereby the split power cable 37 coupled to the first electric connector 21 is electrically coupled to the other split power cable 37 coupled to the second electric connector 22. The horizontal hole 62a formed in the insertion portion 64A is aligned in a straight line with the horizontal hole 67 of the second link mechanism 63.

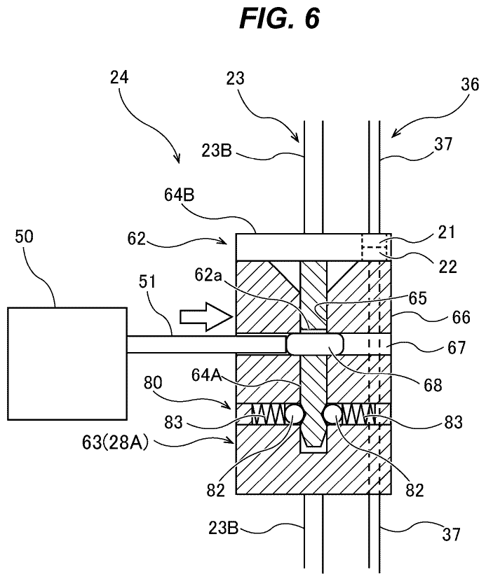

As shown in FIG. 6, when the horizontal hole 62a of the first link mechanism 62 and the horizontal hole 67 of the second link mechanism 63 are aligned in a straight line, the link operating device 50 moves toward the second link mechanism 63 of the coupling link 24, until the operating pin 51 of the link operating device 50 pushes the coupling pin 68 into the horizontal hole 62a. The coupling pin 68 moves into the horizontal hole 62a, so that the first link mechanism 62 and the second link mechanism 63 are coupled by the coupling pin 68. As a result, the upper split suspension cable 23B is coupled to the lower split suspension cable 23B, and the upper split power cable 37 is coupled to the lower split power cable 37.

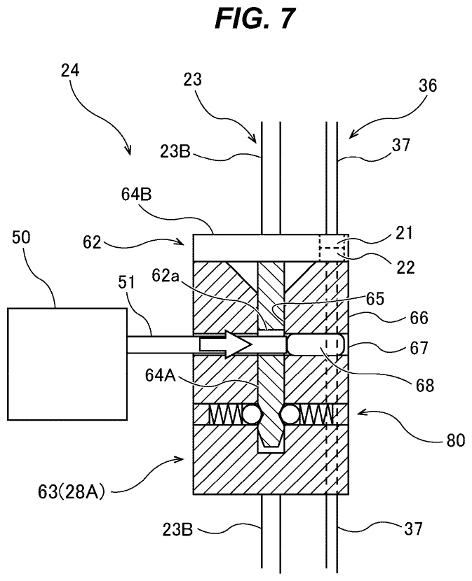

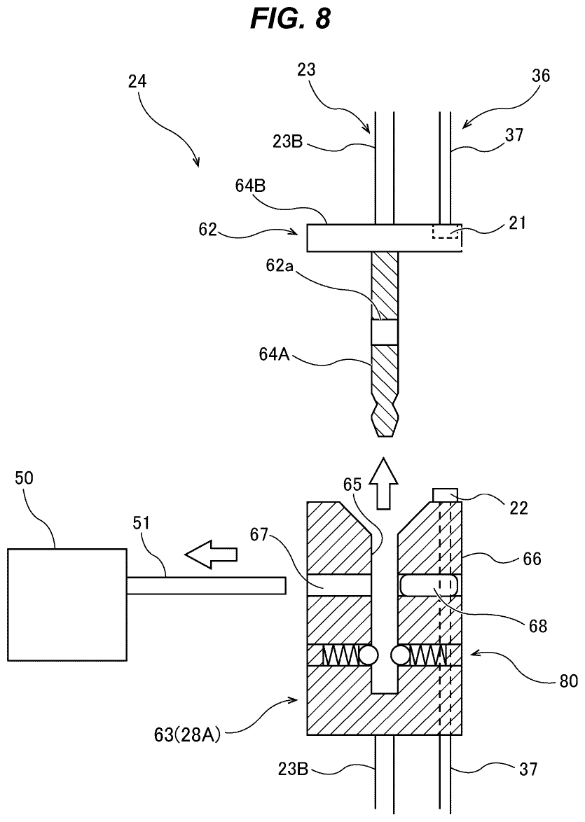

FIGS. 7 and 8 are diagrams for explaining a manner in which the first link mechanism 62 is separated from the second link mechanism 63 by the link operating device 50. As shown in FIG. 7, the link operating device 50 moves toward the second link mechanism 63 of the coupling link 24, until the operating pin 51 of the link operating device 50 pushes the coupling pin 68 out of the horizontal hole 62a. Thereafter, as shown in FIG. 8, the operating pin 51 of the link operating device 50 is pulled out of the horizontal holes 62a and 67, so that the first link mechanism 62 is separated from the second link mechanism 63. As a result, the upper split suspension cable 23B is separated from the lower split suspension cable 23B, and the upper split power cable 37 is separated from the lower split power cable 37.

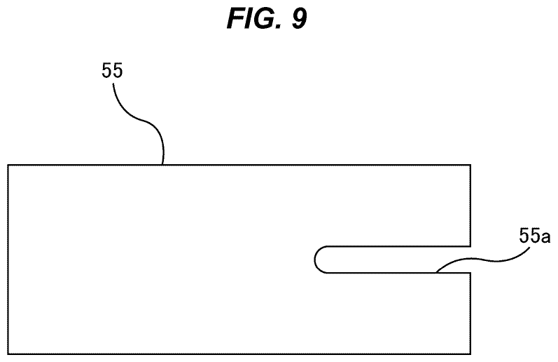

FIG. 9 is a top view showing one embodiment of the support plate 55 shown in FIG. 1. The support plate 55 has a horizontally elongated cut 55a. A width of this cut 55a is larger than the width of the split suspension cable 23B, the width of the split power cable 37, and the widths of the coupling member 28B and the conductive member 28C of the coupling structure 28, while the width of the cut 55a is smaller than the width of the second link mechanism 63 of the coupling link 24 and the width of the link mechanism 28A of the coupling structure 28. Therefore, the split suspension cable 23B, the split power cable 37, the coupling member 28B, and the conductive member 28C can pass through the cut 55a, while the second link mechanism 63 of the coupling link 24 and the link mechanism 28A of the coupling structure 28 cannot pass through the cut 55a.

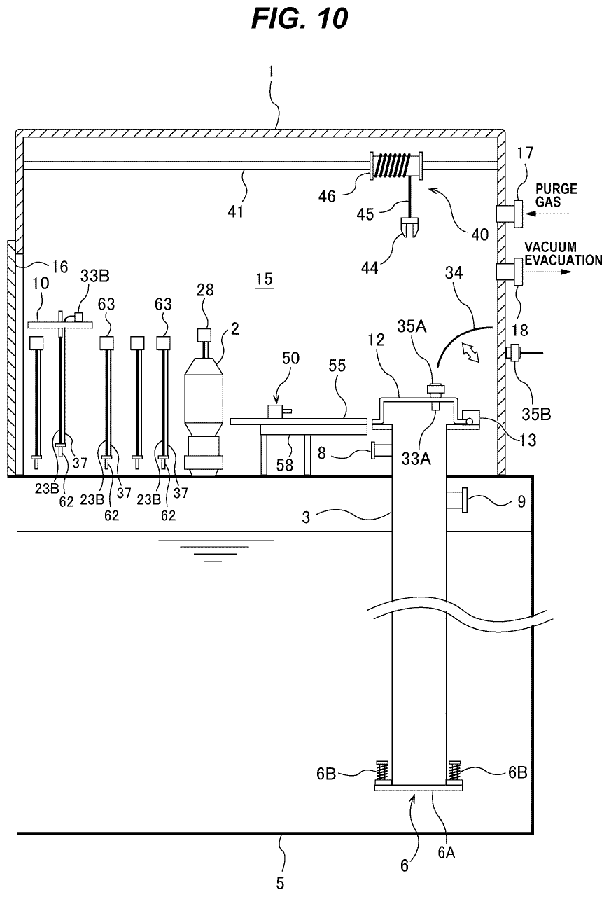

FIG. 10 is a diagram showing a state before the suspension cable 23, the power cable 36, and the submersible pump 2 are carried into the pump column 3. As shown in FIG. 10, the multiple split suspension cables 23B constituting the suspension cable 23, the multiple split power cables 37 constituting the power cable 36, and the submersible pump 2 are disposed in a location away from the pump column 3 in the working space 15 of the working chamber 1. The first link mechanism 62 and the second link mechanism 63 of the coupling link 24 are coupled to each split suspension cable 23B and each split power cable 37 in advance. The head plate 10 is attached to one of the multiple split suspension cables 23B and one of the multiple split power cables 37 in advance. The valve element 6A of the suction valve 6 is pressed against the lower end of the pump column 3 by the multiple springs 6B to close the lower opening of the pump column 3.

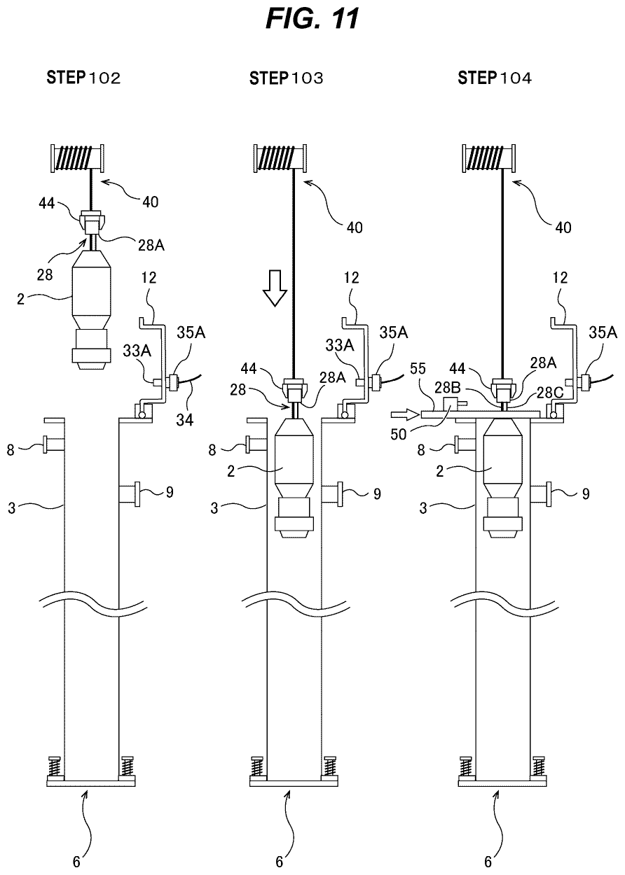

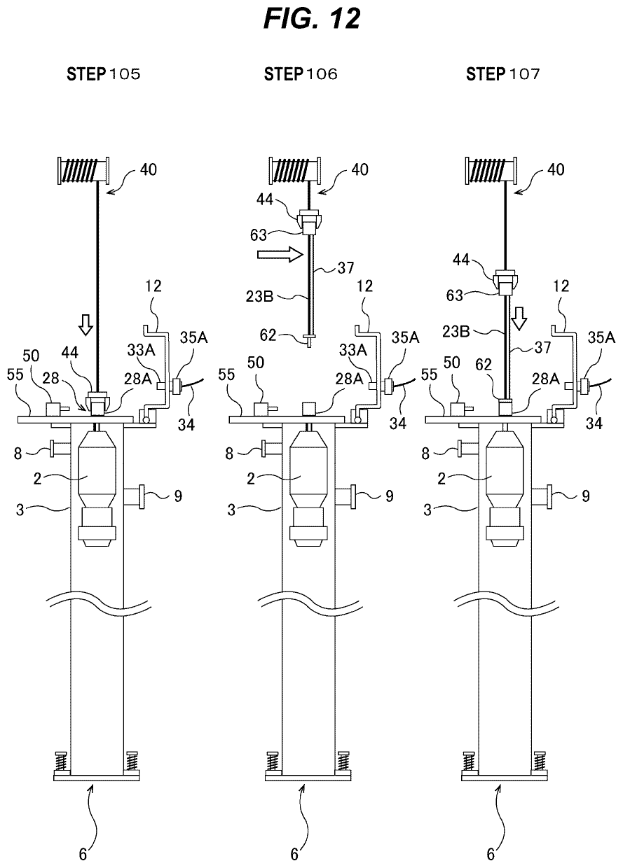

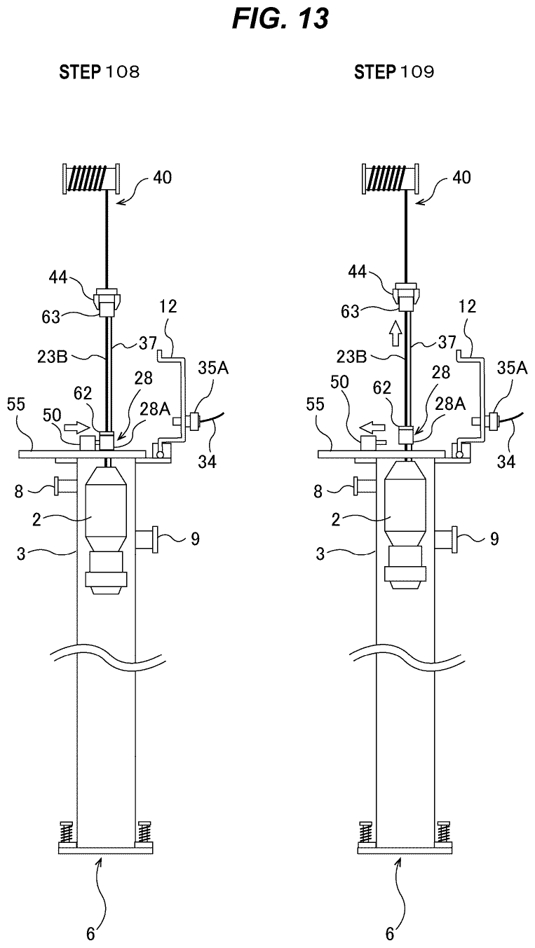

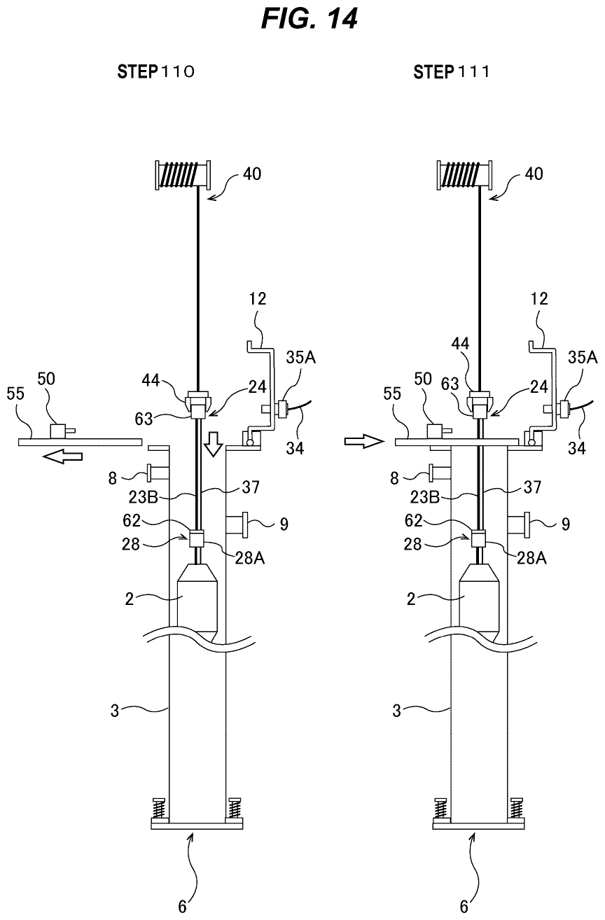

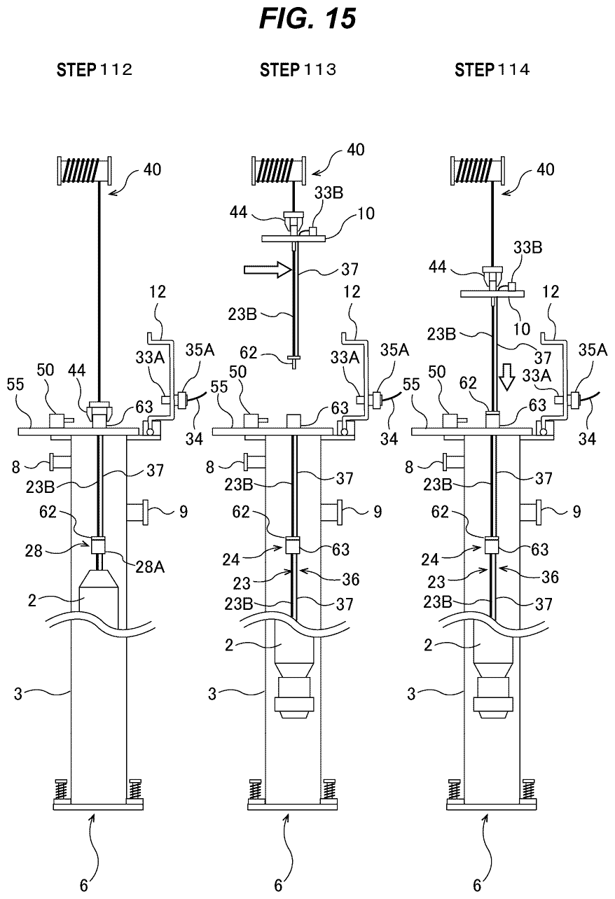

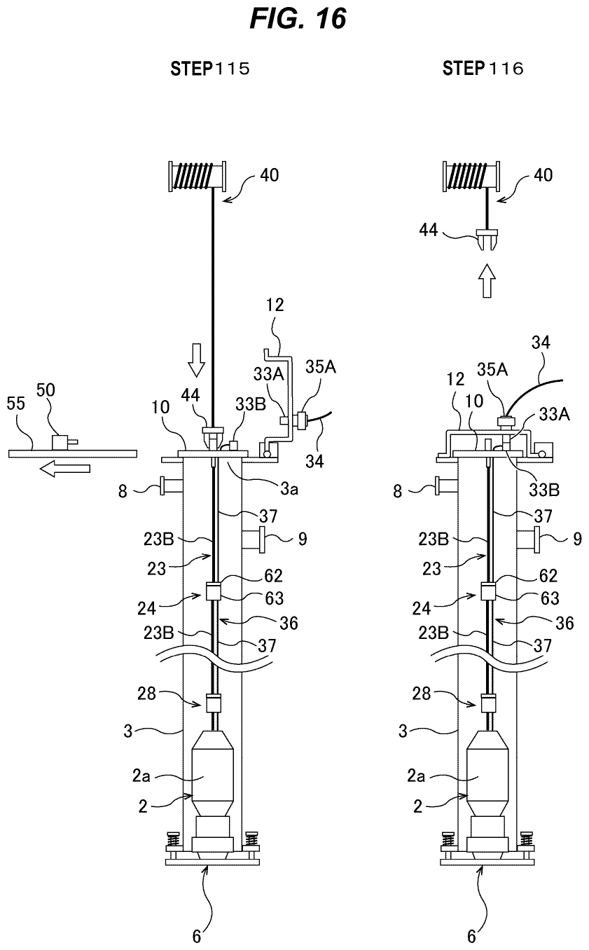

Next, an embodiment of a method for installing the submersible pump 2 in the pump column 3 will be described with reference to FIGS. 10 to 16. A series of operations shown in FIGS. 10 to 16 includes an operation of lowering the submersible pump 2 in the pump column 3, an operation of coupling the multiple split suspension cables 23B one by one, and an operation of coupling the multiple split power cables 37 one by one. Before the operations described below, the liquefied gas is discharged from the pump column 3. Specifically, with the actuator-driven door 12 open, the purge gas is supplied into the working space 15 through the purge-gas inlet port 17 to increase the pressure in the pump column 3, thereby discharging the liquefied gas from the pump column 3 through the suction valve 6. Then, the actuator-driven door 12 is closed.

In step 101, as shown in FIG. 10, with the upper opening 3a of the pump column 3 closed by the actuator-driven door 12, a working person couples the coupling cable 24 to the first electric terminal 35A and the second electric terminal 35B. Thereafter, the working space 15 in the working chamber 1 housing the submersible pump 2 therein is evacuated through the gas outlet port 18. Then, the purge gas (e.g., an inert gas and/or a gas having the same components as the liquefied gas) is supplied from the purge-gas inlet port 17 to the working space 15, until the working space 15 is filled with the purge gas. The submersible pump 2 is exposed to (or contacts) the purge gas in the working space 15, so that air and moisture are removed from the surface of the submersible pump 2. This process is a drying-up process that expels air and moisture from the submersible pump 2. The vacuum evacuation of the working space 15 and the supply of the purge gas to the working space 15 may be repeated.

In step 102, the actuator-driven door 12 is opened, and the submersible pump 2 is transported by the crane 40 to a position over the pump column 3. More specifically, the gripping mechanism 44 of the crane 40 grips the link mechanism 28A of the coupling structure 28 that has been coupled to the submersible pump 2, and the crane 40 transports the submersible pump 2 and the coupling structure 28 together to a position over the pump column 3.

In step 103, the submersible pump 2 and the coupling structure 28 are lowered together by the crane 40, until the submersible pump 2 is moved into the pump column 3 while the link mechanism 28A of the coupling structure 28 is located above the pump column 3.

In step 104, with the link mechanism 28A of the coupling structure 28 located above the pump column 3, the plate actuator 58 (see FIG. 1) moves the support plate 55 and the link operating device 50 toward the pump column 3, so that the support plate 55 covers the upper opening 3a of the pump column 3. As described with reference to FIG. 9, the support plate 55 has the cut 55a, and the width of the cut 55a is larger than the width of the coupling member 28B and the width of the conductive member 28C of the coupling structure 28, and smaller than the width of the link mechanism 28A. In this step 104, the support plate 55 moves onto the pump column 3 so that the coupling member 28B and the conductive member 28C are positioned within the cut 55a of the support plate 55.

In step 105, the crane 40 further lowers the coupling structure 28 and the submersible pump 2 until the link mechanism 28A of the coupling structure 28 comes into contact with the support plate 55. The submersible pump 2 is suspended from the support plate 55 by the coupling structure 28. Specifically, the load of the submersible pump 2 is supported by the support plate 55.

In step 106, the gripping mechanism 44 of the crane 40 releases the link mechanism 28A of the coupling structure 28, and then the crane 40 transports one of the multiple split suspension cables 23B that have been prepared in advance in the working chamber 1 and one of the multiple split power cables 37 that have been prepared in advance in the working chamber 1 to a position above the pump column 3. The second link mechanism 63 of the coupling link 24 is coupled in advance to the upper ends of the split suspension cable 23B and the split power cable 37. The first link mechanism 62 of the coupling link 24 is coupled in advance to the lower ends of the split suspension cable 23B and the split power cable 37. The gripping mechanism 44 of the crane 40 grips the second link mechanism 63 coupled to the upper ends of the split suspension cable 23B and the split power cable 37, so that the crane 40 can transport the split suspension cable 23B, the split power cable 37, and the second link mechanism 63 together and can move them up and down.

In step 107, the split suspension cable 23B and the split power cable 37 are lowered by the crane 40 until the insertion portion 64A of the first link mechanism 62, which is attached to the lower end of the split suspension cable 23B, enters the vertical hole 65 of the link mechanism 28A on the support plate 55 (see FIGS. 2 to 5).

In step 108, the link operating device 50 moves toward the link mechanism 28A on the support plate 55, and the operating pin 51 of the link operating device 50 moves the coupling pin 68 of the link mechanism 28A into the horizontal hole 62a (see FIG. 6). As a result, the first link mechanism 62 is coupled to the link mechanism 28A, and the split suspension cable 23B and the split power cable 37 are coupled to the coupling structure 28.

In step 109, the link operating device 50 moves away from the link mechanism 28A until the operating pin 51 of the link operating device 50 is positioned outside the link mechanism 28A. The crane 40 then slightly pulls up the split suspension cable 23B, the split power cable 37, the coupling structure 28, and the submersible pump 2. The load of the submersible pump 2 is supported by the crane 40.

In step 110, the plate actuator 58 (see FIG. 1) moves the support plate 55 and the link operating device 50 away from the pump column 3. The crane 40 then lowers the split suspension cable 23B, the split power cable 37, the coupling structure 28, and the submersible pump 2, so that the submersible pump 2 is moved in the pump column 3 while the second link mechanism 63 of the coupling link 24 is located above the pump column 3. When the submersible pump 2 is lowered, the load of the submersible pump 2 is applied only to the split suspension cable 23B and is not applied to the split power cable 37.

In step 111, before the second link mechanism 63 attached to the uppermost split suspension cable 23B enters the pump column 3, the plate actuator 58 (see FIG. 1) moves the support plate 55 and the link operating device 50 toward the pump column 3, until the support plate 55 covers the upper opening 3a of the pump column 3. As described with reference to FIG. 9, the width of the cut 55a of the support plate 55 is larger than the width of the split suspension cable 23B and the width of the split power cable 37, and is smaller than the width of the second link mechanism 63. In this step 111, the support plate 55 moves onto the pump column 3 so that the split suspension cable 23B and the split power cable 37 are positioned within the cut 55a of the support plate 55.

In step 112, the crane 40 further lowers the split suspension cable 23B, the split power cable 37, the coupling structure 28, and the submersible pump 2 in the pump column 3 until the second link mechanism 63 coupled to the uppermost split suspension cable 23B and the uppermost split power cable 37 comes into contact with the support plate 55. The submersible pump 2 is suspended from the support plate 55 by the split suspension cable 23B and the coupling structure 28. In other words, the load of the submersible pump 2 is supported by the support plate 55.

Then, steps similar to those in step 106 to step 112 are repeated while adding the remaining multiple split suspension cables 23B one by one and while adding the remaining multiple split power cables 37 one by one until the submersible pump 2 approaches the bottom of the pump column 3. Specifically, while the link operating device 50 operates the coupling links 24 to couple the multiple split suspension cables 23B one by one and couple the multiple split power cables 37 one by one, the crane 40 lowers the multiple split suspension cables 23B, the multiple split power cables 37, and the submersible pump 2 in the pump column 3.

In step 113, when the submersible pump 2 is located close to the bottom of the pump column 3, the final split suspension cable 23B and the final split power cable 37 are added to the suspension cable 23 and the power cable 36, respectively. The head plate 10 is coupled in advance to upper ends of the final split suspension cable 23B and the final split power cable 37.

In step 114, the head plate 10 and the split suspension cable 23B and split power cable 37 coupled to the head plate 10 are lowered by the crane 40, so that the first link mechanism 62 attached to the lower end of the uppermost split suspension cable 23B is coupled to the second link mechanism 63 on the support plate 55, as described with reference to FIGS. 3 to 6.

In step 115, the plate actuator 58 (see FIG. 1) moves the support plate 55 and the link operating device 50 away from the pump column 3. Subsequently, the head plate 10, the split suspension cable 23B, the split power cable 37, the coupling structure 28, and the submersible pump 2 are lowered by the crane 40, until the upper opening 3a of the pump column 3 is closed by the head plate 10. The submersible pump 2 is placed on the suction valve 6. The suction valve 6 opens due to the weight of the submersible pump 2.

In step 116, the gripping mechanism 44 of the crane 40 moves away from the head plate 10. Furthermore, the actuator-driven door 12 is closed, and the first electric contact 33A fixed to the actuator-driven door 12 comes into contact with the second electric contact 33B fixed to the head plate 10. In this way, the installation of the submersible pump 2 into the pump column 3 is terminated.

A working person can automatically install the submersible pump 2 into the pump column 3 by remotely operating the crane 40, the link operating device 50, and the actuator-driven door 12 from outside the working chamber 1. Therefore, the working person is not exposed to a dangerous atmosphere. In addition, since the upper opening 3a of the pump column 3 is located within the closed working space 15, boil-off gas (BOG) is not discharged to the atmosphere. As a result, an amount of the purge gas used to prevent the discharge of the boil-off gas (BOG) to the atmosphere can be substantially reduced to zero. Furthermore, when the submersible pump 2 is carried into the pump column 3, the working space 15 is filled with the gas having the same components as the liquefied gas, so that the entry of gas containing other components, such as air, into the pump column 3 can be prevented.

The power cable 36 (including the multiple split power cables 37) is not permanently installed in the liquefied-gas storage tank 5, and is carried into the pump column 3 together with the suspension cable 23. Therefore, when the power cable 36 deteriorates, the deteriorated power cable 36 can be replaced with new power cable without discharging the liquefied gas in the liquefied-gas storage tank 5.

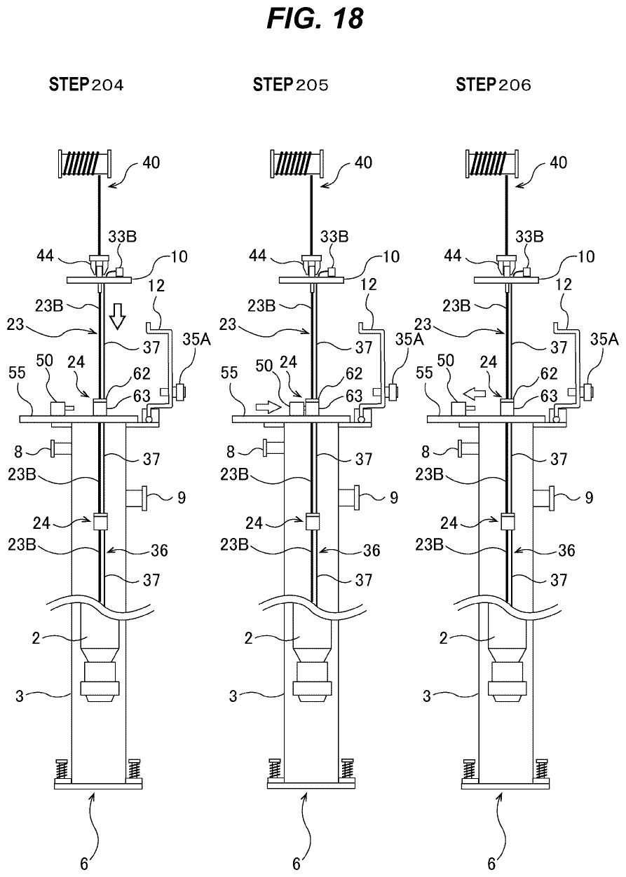

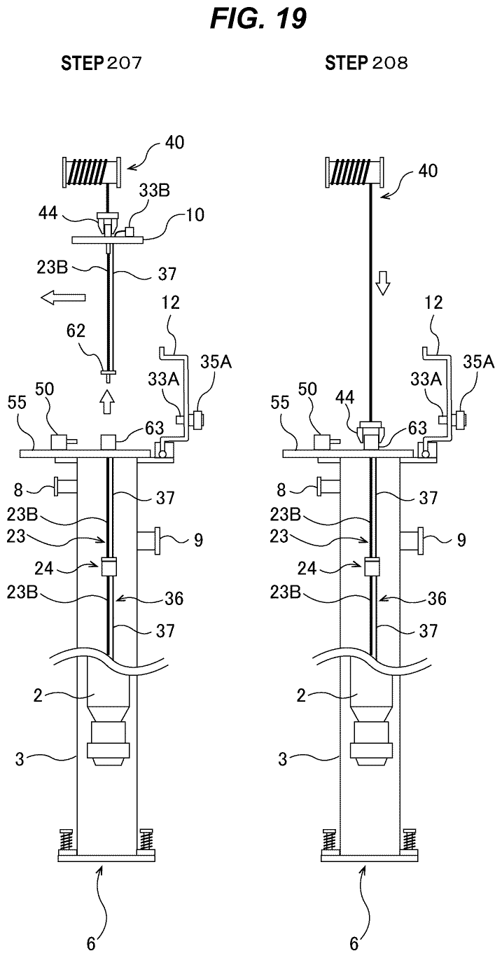

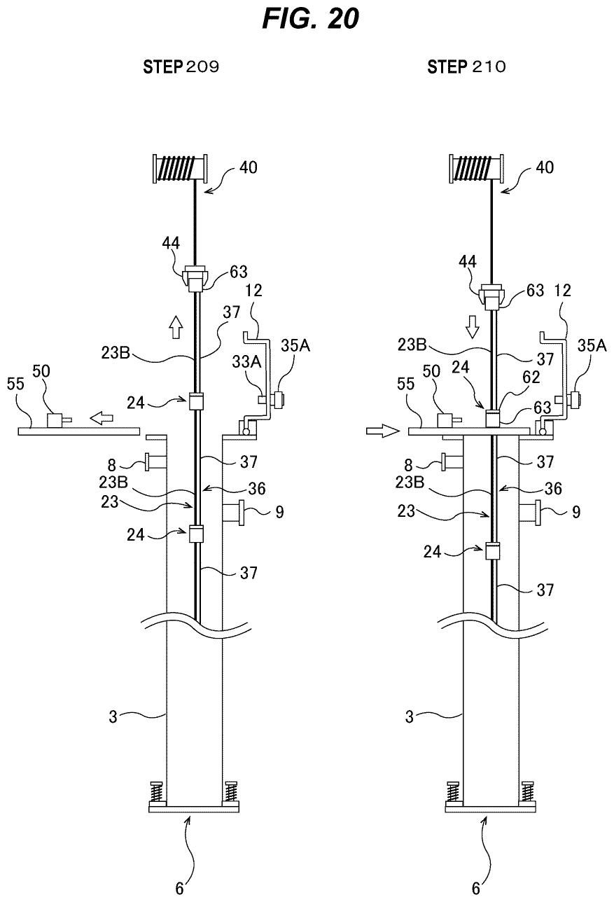

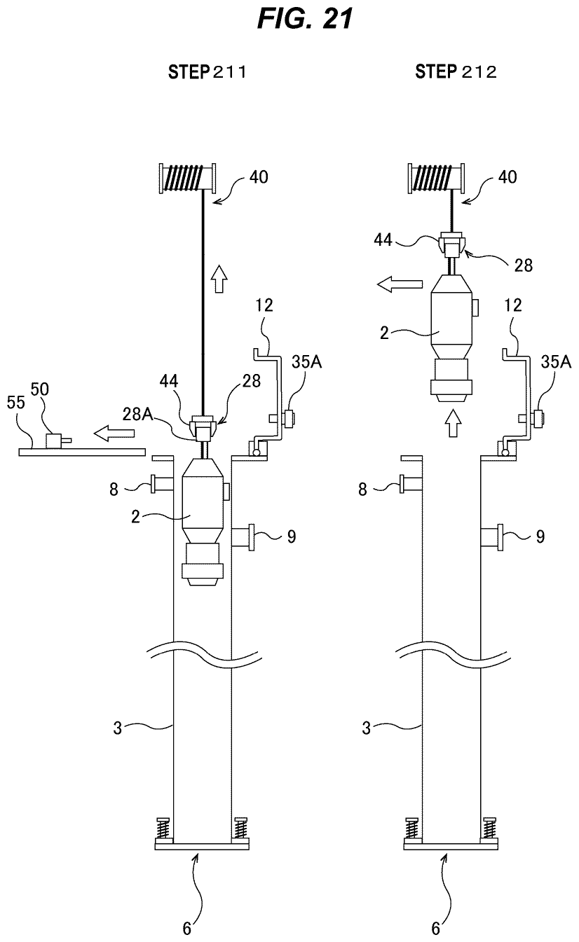

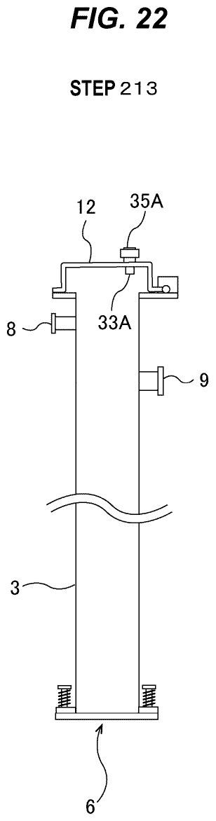

Next, one embodiment of a method for removing the submersible pump 2 from the pump column 3 will be described with reference to FIGS. 1 and 17 to 22. In removing the submersible pump 2, the steps described with reference to FIGS. 10 to 16 are basically performed in reverse order. A series of operations shown in FIGS. 1 and 17 to 22 includes an operation of raising the submersible pump 2 in the pump column 3, an operation of disconnecting the multiple split suspension cables 23B one by one, and an operation of disconnecting the multiple split power cables 37 one by one.

In step 201, with the upper opening 3a of the pump column 3 closed by the head plate 10 and the actuator-driven door 12, a working person removes the coupling cable 34 show in FIG. 1 from the first electric terminal 35A and the second electric terminal 35B. Thereafter, the working space 15 in the working chamber 1 is evacuated through the gas outlet port 18. Then, the purge gas (e.g., an inert gas and/or a gas having the same components as the liquefied gas) is supplied from the purge-gas inlet port 17 into the working space 15 to fill the working space 15. The vacuum evacuation of the working space 15 and the supply of the purge gas to the working space 15 may be repeated.

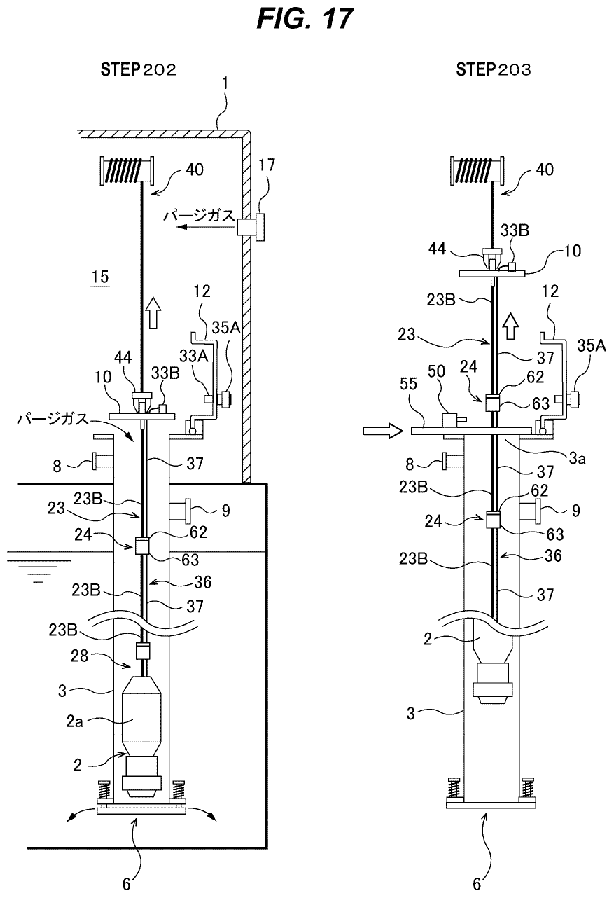

In step 202, as shown in FIG. 17, the actuator-driven door 12 is opened, so that the first electric contact 33A on the actuator-driven door 12 is separated from the second electric contact 33B on the head plate 10. Next, the head plate 10 is gripped by the gripping mechanism 44 of the crane 40. The head plate 10, the multiple split suspension cables 23B, the multiple split power cables 37, the coupling structure 28, and the submersible pump 2 are slightly raised by the crane 40, so that the suction valve 6 is closed. Furthermore, the purge gas is supplied into the working chamber 1 through the purge-gas inlet port 17 to increase the pressure in the pump column 3. As the pressure in the pump column 3 increases, the liquefied gas is discharged from the pump column 3 through the suction valve 6.

In step 203, the head plate 10, the multiple split suspension cables 23B, the multiple split power cables 37, the coupling structure 28, and the submersible pump 2 are pulled up by the crane 40, until the entire uppermost split suspension cable 23B and the entire uppermost split power cable 37 are positioned above the pump column 3. Thereafter, the support plate 55 and the link operating device 50 are moved toward the pump column 3 by the plate actuator 58 (see FIG. 1), until the upper opening 3a of the pump column 3 is covered by the support plate 55.

In step 204, the crane 40 slightly lowers the multiple split suspension cables 23B, the multiple split power cables 37, the coupling structure 28, and the submersible pump 2 until the second link mechanism 63 of the coupling link 24 directly above the support plate 55 comes into contact with the support plate 55. The submersible pump 2 is suspended from the support plate 55 by the split suspension cables 23B and the coupling structure 28. In other words, the load of the submersible pump 2 is supported by the support plate 55.

In step 205, the link operating device 50 moves toward the second link mechanism 63 on the support plate 55, until the operating pin 51 of the link operating device 50 moves the coupling pin 68 of the second link mechanism 63 out of the horizontal hole 62a (see FIG. 7).

In step 206, the operating pin 51 of the link operating device 50 moves away from the second link mechanism 63 on the support plate 55. As a result, the first link mechanism 62 can be separated from the second link mechanism 63, the uppermost split suspension cable 23B can be separated from the other split suspension cables 23B, and the uppermost split power cable 37 can be separated from the other split power cables 37.

In step 207, the uppermost split suspension cable 23B and the uppermost split power cable 37 are pulled up by the crane 40 and then moved to a position away from the pump column 3 (see FIG. 10).

In step 208, the gripping mechanism 44 of the crane 40 grips the second link mechanism 63 on the support plate 55.

In step 209, the remaining split suspension cables 23B, the remaining split power cables 37, the coupling structure 28, and the submersible pump 2 are slightly raised by the crane 40. The plate actuator 58 (see FIG. 1) then moves the support plate 55 and the link operating device 50 away from the pump column 3. Furthermore, the multiple split suspension cables 23B, the multiple split power cables 37, the coupling structure 28, and the submersible pump 2 are raised by the crane 40 until the entire uppermost split suspension cable 23B and the entire uppermost split power cable 37 are positioned above the pump column 3.

In step 210, the plate actuator 58 (see FIG. 1) moves the support plate 55 and the link operating device 50 toward the pump column 3, until the support plate 55 covers the upper opening 3a of the pump column 3. The crane 40 slightly lowers the multiple split suspension cables 23B, the multiple split power cables 37, the coupling structure 28, and the submersible pump 2 until the second link mechanism 63 of the coupling link 24 directly above the support plate 55 comes into contact with the support plate 55.

Then, the same steps as those from step 205 to step 210 are repeated while disconnecting the multiple split suspension cables 23B one by one and while disconnecting the multiple split power cables 37 one by one, until all the split suspension cables 23B and all the split power cables 37 are removed by the crane 40. Specifically, while the link operating device 50 operates the coupling link 21 to disconnect the multiple split suspension cables 23B one by one and while disconnecting the multiple split power cables 37 one by one, the crane 40 raises the multiple split suspension cables 23B, the multiple split power cables 37, and the submersible pump 2 in the pump column 3. When all the split suspension cables 23B and all the split power cables 37 have been removed, the link mechanism 28A of the coupling structure 28 attached to the submersible pump 2 is supported by the support plate 55.

In step 211, the link mechanism 28A of the coupling structure 28 is gripped by the gripping mechanism 44. The coupling structure 28 and the submersible pump 2 are slightly raised by the crane 40. Next, the support plate 55 and link operating device 50 are moved away from the pump column 3 by the plate actuator 58 (see FIG. 1).

In step 212, entireties of the coupling structure 28 and the submersible pump 2 are pulled up out of the pump column 3 by the crane 40, and are then transported to a position away from the pump column 3 within the working space 15 (see FIG. 10).

In step 213, the actuator-driven door 12 is closed.

In step 214, as shown in FIG. 10, the purge gas (e.g., an inert gas and/or a gas having the same components as the liquefied gas) is supplied to the working space 15 of the working chamber 1 through the purge-gas inlet port 17 to fill the working space 15 with the purge gas. The submersible pump 2 is exposed to (contacts) the purge gas in the working space 15, so that the submersible pump 2 is warmed by the purge gas. This is a hot-up process for warming the submersible pump 2. After the hot-up process, the removal of the submersible pump 2 from the pump column 3 is completed.

A working person can automatically remove the submersible pump 2 from the pump column 3 by remotely operating the crane 40, the link operating device 50, and the actuator-driven door 12 from outside the working chamber 1. Therefore, the working person is not exposed to a dangerous atmosphere. In addition, since the upper opening 3a of the pump column 3 is located within the closed working space 15, boil-off gas (BOG) is not released into the atmosphere. As a result, an amount of the purge gas used to prevent the release of boil-off gas (BOG) into the atmosphere can be substantially reduced to zero. Furthermore, when the submersible pump 2 is pulled up from the pump column 3, the working space 15 is filled with a gas having the same components as the liquefied gas, so that the entry of a gas containing other components, such as air, into the pump column 3 can be prevented.

The power cable 36 (including the multiple split power cables 37) is not permanently installed in the liquefied-gas storage tank 5, and is carried out from the pump column 3 together with the suspension cable 23. Therefore, when the power cable 36 deteriorates, the deteriorated power cable 36 can be replaced with new one without discharging the liquefied gas in the liquefied-gas storage tank 5.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to a pump installation apparatus for installing a submersible pump for pressurizing liquefied gas, such as liquefied ammonia, liquefied natural gas (LNG), liquid hydrogen, etc., in a pump column and removing the submersible pump from the pump column. The present invention is further applicable to a method of installing a submersible pump in a pump column using the pump installation apparatus and a method of removing the submersible pump from the pump column using the pump installation apparatus.

### REFERENCE SIGNS LIST

1 working chamber
2 submersible pump
2a electric motor
3 pump column
5 liquified-gas storage tank
6 suction valve
8 parge-gas introduction port
9 discharge port
10 head plate
12 actuator-driven door
13 actuator
15 working space
16 working door
17 parge-gas inlet port
18 gas outlet port
21 first electrical connector
22 second electrical connector
23 suspension cable
23B spit suspension cable
24 coupling link
28 coupling structure
28A rink mechanism
28B coupling member
28C conductive member
33A, 33B electric contact
34 coupling cable
35A, 35B electric terminal
36 power cable
37 split power cable
40 crane
41 support rail
44 gripping mechanism
45 wire
46 take-up device
50 link operating device
51 operating pin
52 actuator
55 support plate
58 plate actuator
62 first link mechanism
62a first horizontal hole
63 third link mechanism
65 recess
66 housing
67 horizontal hole
68 coupling pin
70 purge-gas supply source
71 purge-gas supply line
74 vacuum line
75 tapered guide surface
80 horizontal hole
81 ball
82 spring
86 recess

What is claimed is:

1. A pump installation apparatus for installing a submersible pump in a pump column and removing the submersible pump from the pump column, the submersible pump being used to deliver liquefied gas, the pump installation apparatus comprising:
a working chamber forming an enclosed working space therein;
an actuator-driven door covering an upper opening of the pump column;
a suspension cable configured to suspend the submersible pump in the pump column;
a power cable configured to supply electric power to the submersible pump; and
a crane configured to raise and lower the suspension cable and the power cable,
an upper opening of the pump column, the actuator-driven door, and the crane being located in the working space,
wherein the suspension cable includes a plurality of split suspension cables and a plurality of coupling links configured to couple the plurality of split suspension cables,
the power cable includes a plurality of split power cables and a plurality of electric connectors configured to electrically couple the plurality of split power cables,
the plurality of electric connectors are attached to the plurality of coupling links, respectively, and
the pump installation apparatus further comprises a link operating device configured to operate the plurality of coupling links to cause the plurality of coupling links to couple and separate the plurality of split suspension cables and couple and separate the plurality of split power cables.

2. (canceled)

3. The pump installation apparatus according to claim 12, wherein each of the plurality of coupling links includes a first link mechanism coupled to a lower end of each split suspension cable, a second link mechanism coupled to an upper end of each split suspension cable, and a coupling pin configured to couple and separate the first link mechanism and the second link mechanism, and
the link operating device is configured to move the coupling pin to couple and separate the first link mechanism and the second link mechanism.

4. The pump installation apparatus according to claim 3, wherein each of the plurality of electric connectors includes a first electric connector coupled to a lower end of each split power cable and a second electric connector coupled to an upper end of each split power cable, and
the first electric connector is held by the first link mechanism, and the second electric connector is held by the second link mechanism.

5. The pump installation apparatus according to claim 3, wherein each of the plurality of coupling links further includes a positioning device configured to perform positioning of the first link mechanism and the second link mechanism in a vertical direction.

6. The pump installation apparatus according to claim 5, wherein the positioning device includes a spring that urges the first link mechanism toward the second link mechanism.

7. The pump installation apparatus according to claim 1, wherein the working chamber comprises a purge-gas inlet port communicating with the working space, and a purge-gas supply line coupled to the purge-gas inlet port.

8. A method of installing a submersible pump in a pump column, the submersible pump being used to deliver liquefied gas, the method comprising:
opening an actuator-driven door disposed within an enclosed working space formed by a working chamber, the actuator-driven door being coupled to an upper portion of the pump column;
coupling a suspension cable and a power cable to the submersible pump within the working space; and
lowering the suspension cable, the power cable, and the submersible pump in the pump column by a crane disposed in the working space,
an upper opening of the pump column being located in the working space,
wherein the suspension cable includes a plurality of split suspension cables and a plurality of coupling links configured to couple the plurality of split suspension cables,
the power cable includes a plurality of split power cables and a plurality of electric connectors configured to electrically couple the plurality of split power cables,
the plurality of electric connectors are attached to the plurality of coupling links, respectively, and
lowering the suspension cable, the power cable, and the submersible pump in the pump column comprises lowering the plurality of split suspension cables, the plurality of split power cables, and the submersible pump in the pump column by the crane while operating the coupling links by a link operating device to couple the plurality of split suspension cables one by one and to couple the plurality of split power cables one by one.

9. (canceled)

10. The method according to claim 8, further comprising supplying a purge gas into the working space to expose the submersible pump to the purge gas within the working space before carrying the submersible pump into the pump column.

11. A method of removing a submersible pump from a pump column, the submersible pump being used to deliver liquefied gas, the method comprising:
opening an actuator-driven door located in an enclosed working space formed by a working chamber, the actuator-driven door being coupled to an upper portion of the pump column;
raising a suspension cable, a power cable, and the submersible pump in the pump column by pulling up the suspension cable and the power cable coupled to the submersible pump with a crane, the crane being disposed in the working space;
separating the suspension cable and the power cable from the submersible pump; and
raising the submersible pump from the pump column into the working space by the crane, an upper opening of the pump column being located in the working space,
wherein the suspension cable includes a plurality of split suspension cables and a plurality of coupling links configured to couple the plurality of split suspension cables,
the power cable includes a plurality of split power cables and a plurality of electric connectors configured to electrically couple the plurality of split power cables,
the plurality of electric connectors are attached to the plurality of coupling links, respectively, and
raising the suspension cable, the power cable, and the submersible pump in the pump column comprises raising the plurality of split suspension cables, the plurality of split power cables, and the submersible pump in the pump column by the crane while operating the plurality of coupling links with a link operating device to separate the plurality of split suspension cables one by one and to separate the plurality of split power cables one by one.

12. (canceled)

13. The method according to claim 11, further comprising supplying a purge gas into the working space to expose the submersible pump to the purge gas within the working space after raising the submersible pump from the pump column into the working space.
